(19) United States
(12) Patent Application Publication
(10) Pub. No.: US 2020/0382258 A1
(43) Pub. Date: Dec. 3, 2020

(54) CONTROL FORMAT INDICATOR PATTERNS FOR CONTROL INFORMATION TRANSMISSION

(71) Applicant: GUANGDONG OPPO MOBILE TELECOMMUNICATIONS CORP., LTD., Dongguan (CN)

(72) Inventor: Jing Xu, Dongguan (CN)

(21) Appl. No.: 16/996,729

(22) Filed: Aug. 18, 2020

Related U.S. Application Data
(63) Continuation of application No. PCT/CN2019/086907, filed on May 14, 2019.
(60) Provisional application No. 62/674,789, filed on May 22, 2018.

(51) Int. Cl. H04L 5/00; H04L 5/14; H04W 72/04; H04W 76/27

(52) U.S. Cl. CPC H04L 5/0053; H04L 5/0091; H04W 76/27; H04W 72/042; H04L 5/1469

(57) ABSTRACT

User Equipment, UE, configured to obtain control information, the UE comprising a processing unit configured to obtain a Control Format Indicator, CFI, pattern, wherein the CFI pattern comprises a set of CFI values, and at least one CFI value indicates duration of at least one downlink control channel; and a decoding unit configured to decode downlink control information carried on the at least one downlink control channel based on the CFI pattern.

### CROSS-REFERENCE TO RELATED APPLICATION

This application is a continuation application of International Application No. PCT/CN2019/086907 filed on May 14, 2019, which claims priority to U.S. Provisional Patent Application No. 62/674,789 filed May 22, 2018, the entire contents of both of which are hereby incorporated by reference.

### TECHNICAL FIELD

The present disclosure relates to control information transmission. Specifically, the present disclosure relates to the control format indicator for control information transmission. More specifically, the present disclosure relates to the control format indicator for the transmission of downlink control channels in LTE.

### BACKGROUND

With the advent of Long-Term Evolution (LTE) in telecommunication as well as further generation communication standards and systems, more and more devices are becoming connected to generate and report, convey, share, and/or process data. As most of mobile devices communicate to hierarchically upper base stations, signaling and control information have to be exchanged between the base stations and their corresponding mobile devices to ensure reliable communication.

### SUMMARY

The mentioned problems are solved by the subject-matter of the independent claims. Further preferred embodiments are defined in the dependent claims.

According to an embodiment of the present disclosure, there is provided a user Equipment (UE) configured to obtain control information, wherein the UE comprises a processing unit configured to obtain a Control Format Indicator (CFI) pattern corresponding to multiple downlink control channels, and a decoding unit configured to decode downlink control information carried on each of the downlink control channels based on the CFI pattern.

According to another embodiment of the present disclosure, there is provided a control information obtaining method, by a UE, comprising the steps of obtaining a CFI pattern corresponding to multiple downlink control channels, and decoding downlink control information carried on each of the downlink control channels based on the CFI pattern.

According to another embodiment of the present disclosure, there is provided a network node configured to transmit control information, the network node comprising a processing unit configured to select a CFI pattern corresponding to multiple downlink control channels, and an encoding unit configured to encode downlink control information carried on each of the downlink control channels based on the CFI pattern.

According to another embodiment of the present disclosure, there is provided a control information transmission method, by a network node, comprising the steps of selecting a CFI pattern corresponding to multiple downlink control channels, and encoding downlink control information carried on each of the downlink control channels based on the CFI pattern.

### BRIEF DESCRIPTION OF THE DRAWINGS

Embodiments of the present disclosure, which are presented for better understanding the inventive concepts and which are not to be seen as limiting the invention, will now be described with reference to the figures in which:

FIG. 1 shows a schematic view of communications amongst network nodes and user equipment in a scenario of the related arts;

FIG. 2A shows a general LTE transmission structure for the downlink between a network node and a user equipment;

FIG. 2B shows a control channel region in a subframe for transmission between a network node and user equipment;

FIG. 3 shows a Time Division Duplex (TDD) configuration for one radio frame;

FIGS. 4A and 4B show user equipments configured for channel transmission according to the present disclosure;

FIG. 5 shows a control information transmission method performed by a user equipment according to the present disclosure;

FIG. 6 shows an exemplary table for configuring control channel transmission;

FIG. 7 shows an exemplary table for configuring control channel transmission;

FIGS. 8A and 8B show flow diagrams with regard to a user equipment for configuring control channel transmission;

FIGS. 9A and 9B show network nodes configured for channel transmission according to the present disclosure;

FIGS. 10A and 10B show flow diagrams with regard to control information transmission methods performed by a network node according to the present disclosure, and

FIG. 11 shows a flow diagram with regard to a control information transmission method performed by a user equipment according to the present disclosure.

### DETAILED DESCRIPTION

As introduced above, as most of mobile devices communicate to hierarchically upper base stations, signaling and control information have to be exchanged between the base stations and their corresponding mobile devices to ensure reliable communication.

For successfully exchanging signaling and control information between the base stations and their corresponding mobile devices, various control channels may be used. One control channel may be the Physical Downlink Control Channel (PDCCH) which is used to carry Downlink Control Information (DCI) from the base station to the mobile device, for example to a user equipment (UE). The PDCCH may carry UE-specific scheduling assignments for Downlink (DL) resource allocation, Uplink (UL) grants, Physical Random Access Channel (PRACH) responses, UL power control commands, and/or common scheduling assignments for signaling messages. The PDCCH or any other control channel may therefor occupy symbols in each subframe, wherein the number of symbols used for transmitting the control channel may vary. In this matter, the subframe corresponds to a Transmission Time Interval (TTI) which defines a time interval of a Transport Block Set (TBS) and refers to a transmission time on a transmission path. The PDCCH may, for example, occupy the symbols at the beginning of each subframe, wherein one, two, or three symbols may be used for transmitting the PDCCH.

In order for the UE to be able to accurately receive the control channel, such as the PDCCH, the UE needs to know beforehand in which symbols of the subframe the control channel is to be transmitted. Thus, a Control Format Indicator (CFI) may be used which is an indicator telling the UE how many symbols are used for carrying the control channel at each subframe. Thus, the CFI may be used to tell the UE about the duration of control channel transmission. The CFI may be transmitted using the Physical Control Format Indicator Channel (PCFICH) or Radio Resource Control (RRC) signaling which conveys the number of control symbols in a subframe.

Up until now it has been common to use semi-static CFI configurations to ensure CFI reliability. In this matter, a UE is semi-statically configured by higher layers to perform periodic Channel-state information (CSI) reporting on a Physical Uplink Control Channel (PUCCH). In addition, one single CFI value has been normally used to indicate the number of control symbols in multiple subframes, the number of control symbols being the same for each subframe. However, using one single CFI value and thus the same setting for multiple subframes corresponding to multiple TTIs may result in decreased system efficiency and schedule restrictions due to redundant control channel resources and unequal control load.

It is therefore an object of the present disclosure to provide mechanisms for improved system efficiency and avoidance of schedule restrictions while ensuring correct transmission and processing of the control channel information conveyed in the control channels. It is further an object of the present disclosure to provide corresponding user equipment and network node that can achieve improved system efficiency and can avoid schedule restrictions while ensuring correct transmission and processing of the control channel information.

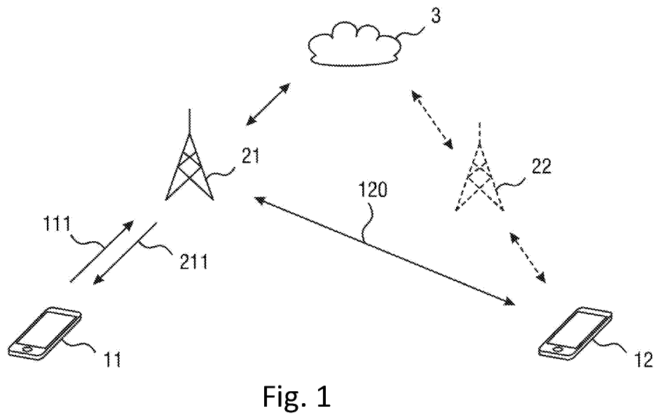

FIG. 1 shows a schematic view of direct communication amongst user equipment (UE) in a scenario of the related art. Accordingly, there is shown a configuration of two UEs shown as an example in the form of mobile phones 11 and 12. These UEs may comprise processing and communication functionalities so as to operate along one or more of the conventional telecommunication standards, including—but not limited to—GSM, PCS, 3GPP, LTE, LTE-A, UMTS, 3G, 4G, 5G. In one or more of these standards communication takes place toward a network node 21 (other denominations such as base station, NodeB, eNodeB, gNodeB, etc. may apply according to the respective standard, topology and infrastructure) on an uplink (UL) direction 111 carrying data from the UE 11 toward the network node 21, and on a downlink (DL) direction 211 carrying data from the network node 21 toward the UE 11. The network node 21 may, in turn, communicate to a background network 3 (core network, internet, and the like). The second UE, e.g. mobile phone 12, may communicate over the same network node 21 over a respective UL and DL direction 120, or over a further network node 22 over respective links (dashed lines).

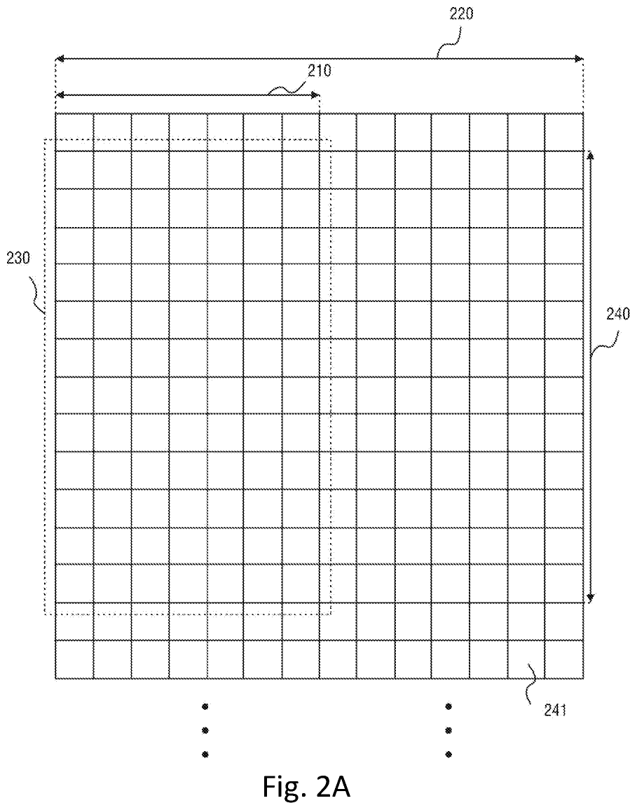

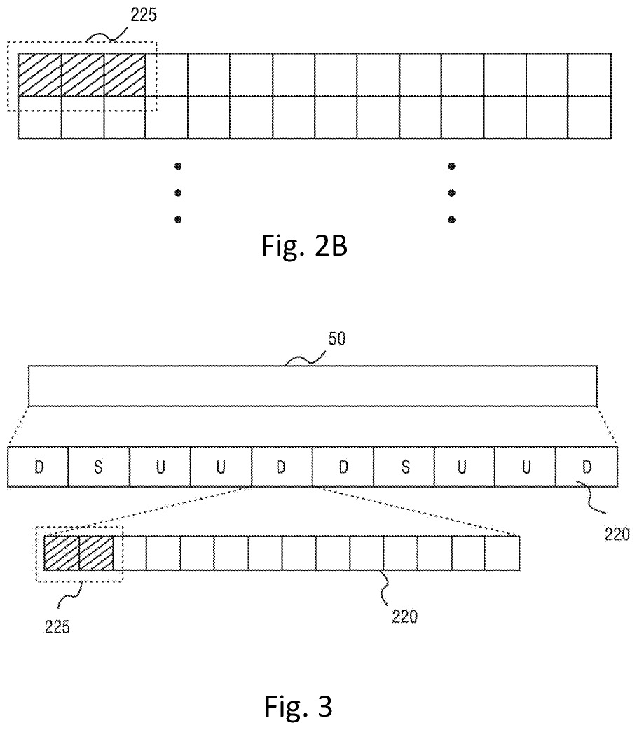

FIG. 2A shows a general LTE transmission structure for the downlink between a network node and a UE. One slot 210 of 0.5 ms may consist of seven consecutive Orthogonal Frequency Division Multiplex (OFDM) symbols, wherein one subframe 220 of 1 ms may comprise two consecutive slots 210. The subframe 220 may correspond to the Transmission Time Interval (TTI) and the slot 210 may correspond to a short Transmission Time Interval (sTTI). One radio frame of 10 ms may comprise 10 subframes, wherein the subframes, for Time Division Duplexing (TDD), may be assigned either to Downlink or Uplink. Some subframes may also be assigned to be special subframes including a guard period, wherein the special subframes are used for switching between Downlink and Uplink transmission. A Resource Block (RB) 230 may consist of 12 consecutive subcarriers 240 over one slot 210. In this matter, a Resource Element (RE) 241 may be one subcarrier on one OFDM symbol.

Different logical data transporting channels may share these resources as shown in FIG. 2A, wherein a Physical Broadcast Channel (PBCH) may be used for basic system configuration information, a Physical Multicast Channel (PMCH) may be used for Multimedia Broadcast and Multicast Services (MBMS), and a Physical Downlink Shared Channel (PDSCH), being the main data transporting channel, may be used to transmit blocks of data called Transport Blocks (TB). One TB may be transmitted during a single TTI and retransmission of incorrectly received TBs may be handled by Hybrid Automatic Repeat Request (HARQ) functionality.

The logical control channels, like PDCCH, may be allocated to a control channel region in a configurable number of OFDM symbols. For example, as shown in FIG. 2B, the control channel region 225 may consist of the symbols at the start of each subframe, wherein the control channels may be allocated to the first symbol, the first two symbols, or the first three symbols of the subframe.

In order to indicate the number and position of symbols used for control information transmission on control channels, such as a downlink control channel like the PDCCH, in each subframe, a Physical Control Format Indicator Channel (PCFICH) may be used which carries the Control Format Indicator (CFI). Instead of using the physical layer for carrying the CFI, a Radio Resource Control (RRC) layer may be used to carry the CFI in a RRC signal. Advantages of signaling provided by the RRC layer may be higher extensibility, as RRC signaling can be extended easily to accommodate additional control information, for example, for enhancement in future releases of, for example, LTE, and secured and reliable transmission.

For example, a network node may transmit the CFI to a UE to let the UE know about the duration of control information transmission. If, for example, the network node sends a CFI with CFI value 1 to the UE and the symbols at the beginning of each subframe are to be used for subsequent control information transmission, the UE expects the control channel, such as a downlink control channel like the PDCCH, to be transmitted on symbol 1 at the beginning of the subframe. If the network node sends a CFI with CFI value 2 to the UE, the UE expects the control channel to be transmitted on symbols 1 and 2 at the beginning of the subframe, while for a CFI value of 3, the UE expects the control channel to be transmitted on symbols 1, 2, and 3 at the beginning of the subframe. Thus, the CFI value may indicate the duration of the control information transmission and the positions of the symbols for the control information transmission to the UE, the control information being carried on the control channels. Once the UE has received the CFI, it may decode the CFI within a subframe and may then decode control information, like downlink control information, based on the number of OFDM symbols and duration of control information transmission indicated in the CFI.

However, this kind of setting as discussed above and as well-known in the technical field has some disadvantages concerning the system efficiency. As a CFI, up until now, only indicates one single CFI value, the control region 225 does not vary among the subframes of, for example, one radio frame. For illustrative purpose, a radio frame 50 is shown in FIG. 3, wherein the radio frame 50 consists of 10 subframes 220. A TDD configuration may indicate the configuration for each subframe 220 in one radio frame, wherein a subframe 220 having a letter “D” in FIG. 3 is a subframe assigned to Downlink transmission, a subframe 220 having a letter “U” in FIG. 3 is a subframe assigned to Uplink transmission, and a subframe 220 having a letter “S” in FIG. 3 is a special subframe used for switching from Downlink transmission to Uplink transmission. A CFI value of 2 may indicate to a UE that the first two symbols of each subframe are used to carry the control channel, as exemplary illustrated in FIG. 3 for a subframe assigned to Downlink. In this example, the control region 225 consists of two symbols indicated by the CFI value 2 (see the hatched first two symbols of the subframe 220).

This setting as described with reference to FIG. 3 does not take into account Uplink/Downlink/special subframe configuration and unequal control load in different subframes leading to a decreased system efficiency and schedule restriction. Using the same CFI value for all subframes in one radio frame may lead to decreased system operability which should be avoided in the present disclosure. Thus, the following embodiments deal with the mentioned problems by considering CFI patterns for improving the system efficiency while avoiding schedule limitations and redundant control channel resources. CFI patterns may be used to consider different downlink control channel durations in different subframes which may be beneficial for unequal control load in different subframe.

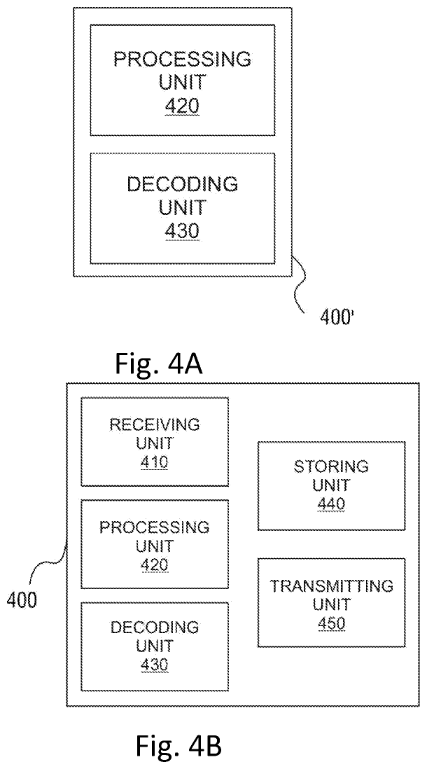

FIG. 4A shows one embodiment of a UE 400′ which may be configured to obtain control information. The UE 400′ may comprise a processing unit 420 which may be configured to obtain a CFI pattern, wherein the CFI pattern comprises a set of CFI values. At least one CFI value may indicate duration of at least one downlink control channel.

Additionally, the UE 400′ may comprise a decoding unit 430 which may be configured to decode downlink control information carried on the at least one downlink control channel based on the CFI pattern. In other words, the CFI pattern may comprise CFI information which may set the duration of control information transmission and/or the symbol position for carrying control channels according to varying subframe configurations in one radio frame.

FIG. 4B shows another embodiment of a UE 400 which may comprise, additionally to the processing unit 420 and the decoding unit 430 of UE 400′ with respect to FIG. 4A, a receiving unit 410 configured to receive information indicating a CFI pattern, the CFI pattern including CFI information indication duration and/or symbol position for carrying control channels, like downlink control channels, in at least two subframes. The duration and position for carrying the downlink control channels may depend on a configuration of each subframe.

A processing unit 420 of UE 400, the processing unit 420 of UE 400 having the same functions as the processing unit 420 of UE 400′, may be configured to obtain the CFI pattern from the information received by the receiving unit 410, wherein the CFI pattern may correspond to multiple downlink control channels. Additionally, a decoding unit 430 of the UE 400, the decoding unit 430 of UE 400 having the same functions as the decoding unit 430 of UE 400′, may be configured to decode downlink control information carried on each of the downlink control channels based on the CFI pattern. UEs 400 and 400′ may be configured to transmit control information in LTE and the downlink control channels may be a PDCCH or a short Physical Downlink control channel (sPDCCH).

Additionally, UE 400 may comprise a storing unit 440 which may store the CFI pattern including the CFI information for each subframe, and a transmitting unit 450 which may transmit data to a network node, e.g. to a base station, during Uplink transmission.

The information indicating the CFI pattern and received by the receiving unit 410 may comprise information defining the CFI pattern or may comprise information referring to a predefined CFI pattern. If the information defining the CFI pattern is transmitted from a network node to the corresponding UE 400 or 400′, the UE 400 or 400′, particularly the processing unit 420, can obtain the CFI pattern directly from the transmitted information. This means that the information defining the CFI pattern may be equal to the CFI pattern itself.

On the other hand, if the information referring to a predefined CFI pattern is transmitted from the network node to the UE 400 or 400′, the processing unit 420 of the UE 400 or 400′ may obtain, for example, the CFI pattern corresponding to the received information from a plurality of predefined and pre-stored CFI patterns. This means that, for example, the UE 400 or 400′ receives one value or pointer as information from the network node and obtains the CFI pattern corresponding to the received information from a pre-stored list of CFI patterns which have been configured beforehand. The pre-stored list of CFI patterns may be, for example, stored in the storing unit 420 in advance.

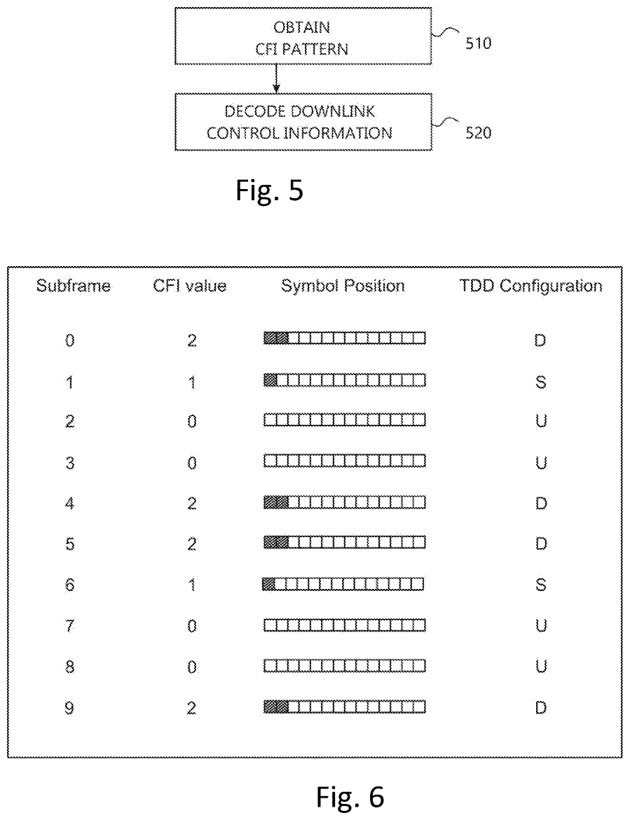

FIG. 5 illustrates a control information obtaining method carried out by the UE 400 or 400′, wherein the method comprises the step 510 of obtaining CFI pattern. The CFI pattern may comprise a set of CFI values, and at least one CFI value may indicate duration of at least one downlink control channel. The processing unit 420 of UE 400 or 400′ may obtain the CFI pattern from information indicating the CFI pattern as described in more detail above. For example, the receiving unit 410 may receive the information indicating the CFI and the processing unit 420 may obtain the CFI pattern from the received information, or the processing unit 420 may obtain or receive the CFI pattern from information already stored beforehand by accessing a memory, accessing a pointer, etc.

Subsequently, in step 520, the UE 400 or 400′, in particular the decoding unit 430, may decode downlink control information carried on each of the downlink control channels based on the CFI pattern.

According to an embodiment of the present disclosure, the CFI pattern obtained by the UE 400 and 400′ from a network node may be configured semi-statically. If the CFI pattern is configured semi-statically, the UE 400 and 400′ may be configured to receive a Radio Resource Control (RRC) signal from a network node, the information indicating the CFI pattern being carried in the RRC signal, wherein the processing unit 420 may be configured to receive or obtain the CFI pattern from the RRC signal. Again, the information indicating the CFI pattern and received by the UE 400 and 400′ may be information defining the CFI pattern or may be information referring to a predefined CFI pattern, such as a pointer.

The CFI information included in the CFI pattern may, for example, indicate that the downlink control channel, like a PDCCH, is transmitted on symbols 1 and 2 at the beginning of a subframe assigned for Downlink transmission, and may indicate that the downlink control channel is transmitted solely on symbol 1 at the beginning of a special subframe. Thus, the CFI information included in the CFI pattern is able to indicate the duration of the downlink control channels and the positions of the symbols carrying the downlink control channels individually for every subframe in one frame, e.g. a radio frame, wherein the duration of the downlink control channels and positions of the symbols may depend on the subframe configuration. In other words, the CFI information in the CFI pattern may indicate the duration of downlink control channels and the positions of the symbols carrying the downlink control channels, wherein the duration of the downlink control channel may vary among different subframes. Note that the control channel does not always have to be transmitted at the beginning of each subframe and that any other position of the symbols for transmitting the control channel may be possible.

The configuration of a subframe, i.e. the subframe configuration, may indicate that the subframe is assigned to Downlink transmission or Uplink transmission, or may indicate that the subframe is a special subframe used for switching between Downlink transmission and Uplink transmission. As already described above, a TDD configuration may then indicate the subframe configuration for each subframe in a radio frame, wherein, if the TDD configuration includes a letter “D”, the corresponding subframe or TTI is assigned to Downlink transmission. If the TDD configuration includes a letter “U”, the corresponding subframe or TTI is assigned to Uplink transmission. Finally, if the TDD configuration includes a letter “S”, the corresponding subframe or TTI is a special subframe used for switching from Downlink transmission to Uplink transmission. The same configuration is also valid for a slot within a radio frame, the slot corresponding to a sTTI.

In one embodiment, the CFI pattern may comprise multiple CFI values, for example a set of CFI values, wherein each CFI value may indicate a duration of downlink control channel. Each CFI value may further indicate position of at least one symbol carrying the downlink control channels in the corresponding subframe.

In another embodiment, the set of CFI values may correspond to a set of TTIs or sTTIs within each frame, wherein on each frame the downlink control information may be transmitted. The frame on which the downlink control information is transmitted may correspond to a radio frame which comprises 10 subframes, each subframe comprising two slots. Each subframe may correspond to one TTI and each slot may correspond to one sTTI. The set of TTIs may comprise downlink TTI and special TTI, while the set of sTTIs may comprise downlink sTTI and special sTTI. Additionally, the set of TTIs may comprise uplink TTI and the set of sTTIs may comprise uplink sTTI.

In this matter, the subframe corresponding to a downlink TTI or the slot corresponding to a downlink sTTI is a subframe or slot assigned to Downlink, while the subframe corresponding to an uplink TTI or the slot corresponding to an uplink sTTI is a subframe or slot assigned to Uplink. Moreover, the subframe corresponding to a special TTI or the slot corresponding to a special sTTI is a special subframe or a special slot.

The set of CFI values may comprise a plurality of CFI values, wherein each CFI value may indicate the duration for downlink control transmission and/or position of at least one symbol which may be used for carrying the downlink control channel. A CFI value of 1 may, for example, indicate to the UE 400 and 400′ that the first symbol at the beginning of a subframe is used for downlink control channel transmission, wherein the duration is one TTI.

One possibility is that the set of CFI values consists of a plurality of CFI values, wherein each CFI value corresponds to one subframe/slot in one radio frame, the subframe/slot corresponding to TTI/sTTI. Thus, each CFI value of a set of CFI values may correspond to a TTI or sTTI. One or more TTIs or sTTIs corresponding to at least one CFI value may be configured for at least one downlink control channel.

As there may be 10 subframes or 10 TTIs in one radio frame, the set of CFI values may consist of 10 CFI values, each CFI value indicating the number and/or position of the symbols carrying the downlink control channel in the corresponding subframe. For example, the set of CFI values may be {2,1,0,0,2,2,1,0,0,2} for the set of subframes corresponding to a set of TTI/sTTI {0,1,2,3,4,5,6,7,8,9}, wherein the radio frame consisting of the set of subframes may have the TDD configuration {D S U U D D S U U D}. Thus, the duration downlink control channel transmission, for example the sPDCCH/PDCCH duration, may be {2,1,0,0,2,2,1,0,0,2} based on the set of CFI values.

In this matter, the downlink control channel duration values may indicate the number of TTIs/sTTIs or the number of symbols which are used in each subframe for downlink control information transmission. If the symbols are fixed to a specific part of the subframe, the number of symbols may also indicate the position of the symbols in the subframe. If, for example, the symbols for carrying the downlink control channel are allocated at the beginning of each subframe, the CFI value indicating the downlink control channel duration indicates the position of the symbols.

This example is also illustrated in FIG. 6 which shows an exemplary table having columns for the respective subframe in one radio frame, the CFI value, the symbol position in the corresponding subframe, and the TDD configuration for each subframe 0 to 9 in one radio frame. Here, the symbols for carrying the control channel are allocated at the beginning of each subframe, but any other position within the subframe may be possible. The exemplary table shows that by using a CFI pattern with a set of CFI values, each subframe can be configured individually resulting in improved system efficiency.

In more detail, according to FIG. 6, the CFI pattern is {2, 1, 0, 0, 2, 2, 1, 0, 0, 2} for subframes 0 to 9 within one radio frame having a TDD configuration of {D S U U D D S U U D}. For example, for subframe 0 being assigned to Downlink transmission (see TDD configuration “D”), the CFI value is 2 which is obtained by taking the first CFI value from the CFI pattern. Thus, the first two symbols of subframe 0 are used for the downlink control channel (see the hatched first two symbols in the subframe drawn in column “Symbol Position”). On the other hand, subframe 2 assigned to Uplink transmission (see TDD configuration “U”) has the CFI value 0, such that no symbol in the corresponding subframe is used for the downlink control channel (see no hatched symbols in the drawn subframe).

In another embodiment, the CFI pattern may indicate a set of CFI values corresponding to a set of TTIs within a frame on which the downlink control information is transmitted, wherein the set of sTTIs us a set of downlink TTIs and/or special TTIs. If the CFI pattern indicates a set of CFI values corresponding to a set of sTTIs within a frame on which the downlink control information is transmitted, the set of sTTIs may be a set of downlink sTTIs and/or special sTTIs. The downlink control channel duration for the subframes/slots assigned to Uplink transmission are set to zero.

A downlink TTI/sTTI may correspond to a subframe/slot assigned to Downlink transmission and a special TTI/sTTI may correspond to a special subframe/special slot. Again, each CFI value of the set of CFI values may indicate a duration of downlink control channel and/or a position of at least one symbol carrying the downlink control channel in the corresponding subframe, wherein, in this embodiment, the subframe is assigned to Downlink transmission or is a special subframe. For example, the set of CFI values may be {2,1,2,2,1,2} which may correspond to the set of TTIs/sTTIs {0,1,4,5,6,9}. The TDD configuration for a radio frame comprising the set of TTIs/sTTis may be, for example, {D S U U D D S U U D}. Thus, in this example, solely the downlink control channel duration for the subframes/slots assigned to Downlink transmission and for special subframes/slots are given in the set of CFI values. The downlink control channel duration for the subframes/slots assigned to Uplink transmission is not explicitly given in the CFI pattern comprising the set of CFI values but can be set to zero. In other words, the downlink control channel duration for the subframes/slots assigned to Uplink transmission can be implicitly derived from the CFI pattern by automatically setting the downlink control channel duration for the subframes/slots assigned to Uplink transmission to zero. Again, each subframe/slot can be configured individually resulting in improved system efficiency, while the length of the CFI pattern is shortened.

According to another embodiment, the CFI pattern may comprise a CFI value, wherein the processing unit 420 is further configured to obtain multiple durations of the downlink control channel, the multiple durations corresponding to multiple TTIs or sTTIs within a frame on which the downlink control information is transmitted. The frame on which the downlink control information is transmitted may again correspond to a radio frame which comprises 10 subframes, each subframe consisting of two slots. Each subframe may correspond to one TTI and each slot may correspond to one sTTI.

For example, the UE 400 and 400′ may receive information indicating a CFI pattern from a network node as explained above and the processing unit 420 may be able to obtain the CFI pattern from the received information. The obtained CFI pattern may comprise a CFI value, wherein the CFI value refers to a set of TTIs or sTTIs having multiple TTIs or sTTIs and wherein the multiple TTIs or sTTIs may be part of one radio frame having a specific TDD configuration.

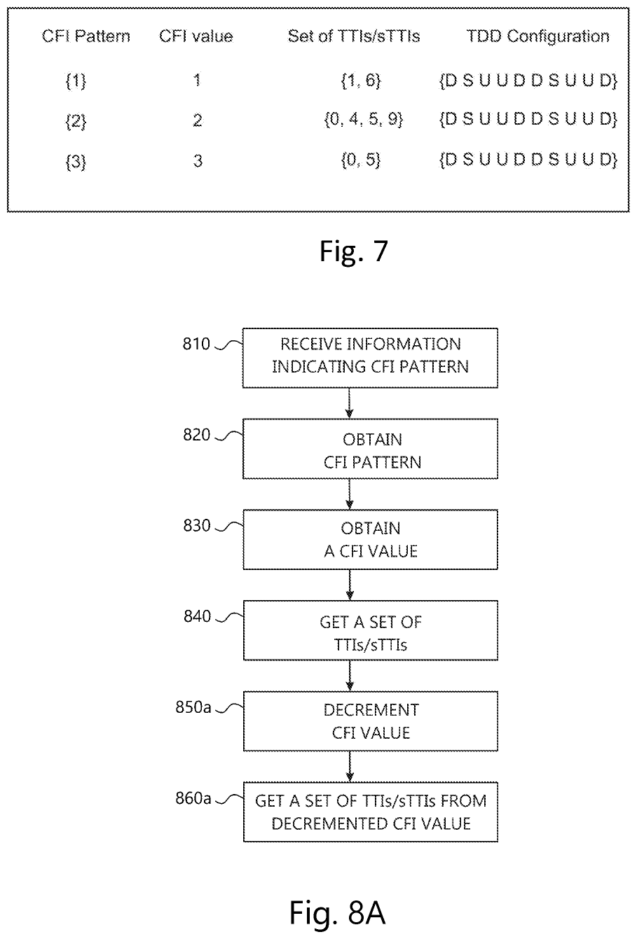

As illustrated in FIG. 7, the processing unit 420 may, for example, obtain a CFI pattern with a CFI value of 2 and may obtain the corresponding set of TTIs/sTTIs {0, 4, 5, 9} from, for example, a table stored in the UE 400 and 400′, such as in the storing unit 440. The set of TTIs/sTTIs {0, 4, 5, 9} may be part of a radio frame with the TDD configuration {D S U U D D S U U D}, such that the decoding unit 430 of the UE 400 is able to decode downlink control information carried on each of the downlink control channels based on the CFI pattern. In this example, the duration of downlink control channel transmission for each TTI/sTTI, i.e. each subframe/slot, assigned to Downlink transmission is 2.

In order to now obtain the duration of downlink control channel transmission for each special TTI/sTTI corresponding to each special subframe/slot in the radio frame with the same TDD configuration {D S U U D D S U U D}, the UE 400 and UE 400′ may either receive information indicating another CFI pattern corresponding to another set of TTIs/sTTIs, or the processing unit 420 may be able to obtain the CFI pattern based on the already obtained CFI pattern with the CFI value 2, the CFI value 2 indicating the set of downlink TTIs/sTTIs {0, 4, 5, 9}. In one embodiment, the processing unit 420 may be configured to decrement the received CFI value indicating the set of downlink TTIs/sTTIs in order to obtain the CFI value indicating the set of special TTIs/sTTIs.

For, example, the processing unit 420 may be configured to decrement the obtained CFI value 2 indicating the set of downlink TTIs/sTTIs by 1 and may obtain the CFI value 1 indicating the set of special TTIs/sTTIs. The processing unit 420 may obtain the corresponding set of special TTIs/sTTIs by referring to a table stored in the storage unit 440. An exemplary table is shown in FIG. 7, wherein the CFI value 1 corresponds to the set of special TTIs/sTTIs {1, 6} being part of a radio frame, the radio frame having the TDD configuration {D S U U D D S U U D}. Thus, the duration of downlink control channel for each special TTI/sTTI is 1, while the duration of downlink control channel for each downlink TTI/sTTI is 2, wherein solely information indicating a CFI pattern with one CFI value has been received by the UE 400 and 400′ and the other CFI value has been obtained implicitly by the processing unit 420.

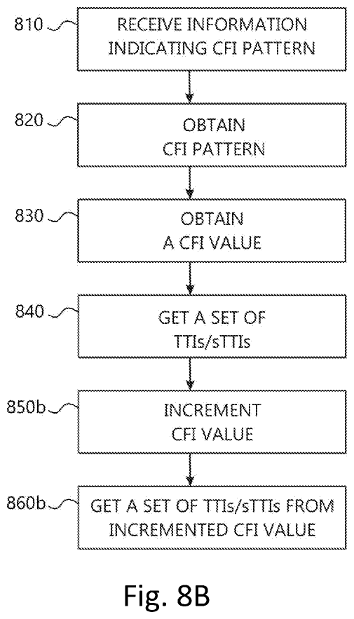

This embodiment is also illustrated in the flow diagram of FIG. 8A, wherein in step 810 the UE 400 and 400′, e.g. the receiving unit 410, may receive information indicating a CFI pattern with a CFI value through signaling. In step 820, the processing unit 420 may obtain the CFI pattern from the received information and may, in step 830, obtain the CFI value from the obtained CFI pattern. Then, the processing unit 420 may get a set of TTIs/sTTIs corresponding to the obtained CFI value by retrieving the set of TTIs/sTTIs from a memory of the UE 400 and 400′, such as the storing unit 440. The UE 400 and 400′ may store the correspondence between a CFI value and a set of TTIs/sTTIs in a memory such that the processing unit 420 is able to retrieve information about a set of TTIs/sTTIs as needed. The set of TTIs/sTTis may, for example, be assigned to Downlink transmission, Uplink transmission, or may be a set of special TTIs/sTTIs.

The processing unit 420 may further decrement, in step 850a, the CFI value obtained from the CFI pattern and may, in step 860a, get a set of TTIs/sTTIs from the decremented CFI value by referring to the memory of UE 400 and 400′ and retrieving the set of TTIs/sTTIs corresponding to the CFI value. The set of TTIs/sTTis may again, for example, be assigned to Downlink transmission, Uplink transmission, or may be a set of special TTIs/sTTIs. It is to be noted that the set of TTIs/sTTIs for Downlink transmission, i.e. the downlink set of TTIs/sTTIs, may correspond to subframes/slots for Downlink transmission, i.e. downlink subframes/slots, the set of TTIs/sTTIs for Uplink transmission, i.e. the uplink set of TTIs/sTTIs, may correspond to subframes/slots for Uplink transmission, i.e. uplink subframes/slots, and the set of special TTIs/sTTIs may correspond to special subframes/slots.

In another embodiment, the processing unit 420 may again obtain a CFI value from a CFI pattern, the information indicating the CFI pattern having been, for example, received by UE 400 and 400′ beforehand. As illustrated as an example in FIG. 7, the processing unit 420 may obtain the CFI value 2 corresponding to the set of TTIs/sTTIs {0, 4, 5, 9}. The set of TTIs/sTTIs is again a part of the radio frame with the TDD configuration {D S U U D D S U U D}. Now, the processing unit 420 may refer to the CFI value of the CFI pattern to implicitly obtain a second CFI value by incrementing the CFI value from the CFI pattern. For example, the processing unit 420 may increment the CFI value 2 from the CFI pattern by 1 and may obtain a second CFI value 3 corresponding to a second set of TTIs/sTTIs {0, 5} being part of the same radio frame with the TDD configuration {D S U U D D S U U D}.

FIG. 8B exemplary illustrates this embodiment, wherein the steps 810, 820, 830, and 840 of FIG. 8B are equal to the steps 810, 820, 830, and 840 of FIG. 8A. Thus, for conciseness reasons, a detailed description of steps 810, 820, 830, and 840 of FIG. 8B is omitted at this point.

In FIG. 8B, after having obtained a CFI value from an obtained CFI pattern and having retrieved a set of TTIs/sTTIs in steps 830 and 840, the processing unit 420 may further increment, in step 850b, the CFI value obtained from the CFI pattern and may, in step 860b, get a set of TTIs/sTTIs from the incremented CFI value by referring to the memory of the UE 400 and 400′, such as the storing unit 440, storing the correspondence between the CFI value and the set of TTIs/sTTIs, and by retrieving the corresponding set of TTIs/sTTIs. The set of TTIs/sTTis may again, for example, be assigned to Downlink transmission, Uplink transmission, or may be a set of special TTIs/sTTIs.

In summary, the processing unit 420 may be configured to obtain a first CFI value from a CFI pattern, the first CFI value corresponding to a first set of TTIs/sTTIs, and to obtain a second CFI value by decrementing or incrementing the first CFI value from the CFI pattern, wherein the second CFI value corresponds to a second set of TTIs/sTTIs. By ensuring individual CFI values for various TTIs/sTTIs even if only one CFI value is included in the CFI pattern, the CFI value transmission is simplified while system efficiency is improved and schedule restrictions are avoided. In addition, by ensuring individual CFI values for various TTIs/sTTIs even if only one CFI value is included in the CFI pattern, correct transmission and processing of the control channel information is ensured while ensuring simplified CFI value transmission. Note that incrementing or decrementing the CFI value by 1 is just an example and there is no restriction on the relationship of CFI values for different sets of TTIs/sTTIs.

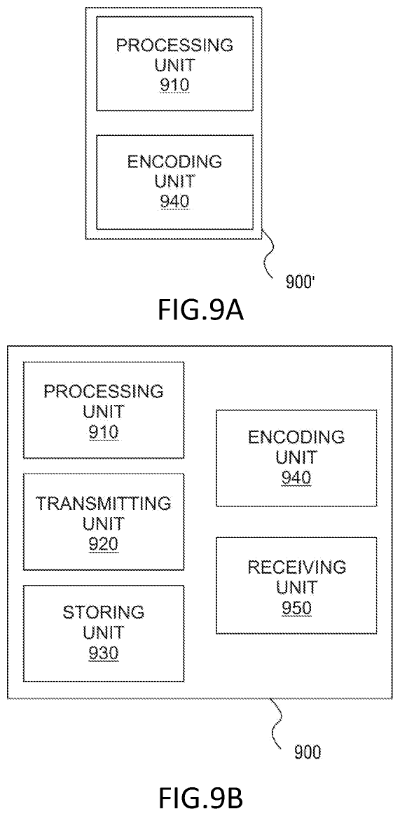

A network node as mentioned in several embodiments above may comprise components as illustrated in FIGS. 9A and 9B. According to an embodiment illustrated in FIG. 9A, a network node 900′ may comprise a processing unit 910 configured to select a CFI pattern, wherein the CFI pattern comprises a set of CFI values, and at least one CFI value indicates duration of at least one downlink control channel, and an encoding unit 940 configured to encode downlink control information carried on each of the downlink control channels based on the CFI pattern. The CFI pattern has been explained in much detail above and thus a detailed description is omitted at this point. The processing unit 910 may, for example, select a CFI pattern from a plurality of preconfigured CFI patterns stored in the network node.

According to another embodiment illustrated in FIG. 9B, a network node 900 may comprise the processing unit 910 and the encoding unit 940 of network node 900′ and may further comprise a transmitting unit 920, a storing unit 930, and a receiving unit 950. The transmitting unit 920 may transmit data on a downlink direction toward a UE, e.g. UE 400 or 400′, while the receiving unit 950 may receive data on an uplink direction from a UE, e.g. UE 400 or 400′. The storing unit 930, such as a memory, may store data or CFI patterns used for encoding downlink control information.

According to another embodiment, the transmitting unit 920 may transmit a Radio Resource Control (RRC) signal to a UE, e.g. UE 400 or 400′, wherein the information indicating the CFI pattern is carried in the RRC signal, the CFI pattern being configured semi-statically.

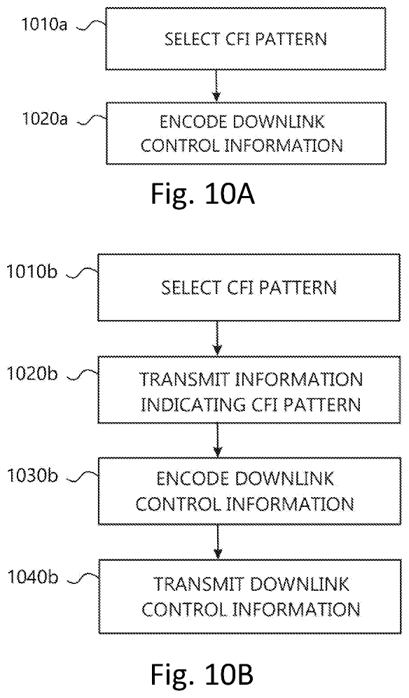

The flow charts of FIGS. 10A and 10B illustrate exemplary control information transmission methods performed by a network node 900′ or 900. FIG. 10A illustrates one embodiment of a method carried out by the network node 900′ or 900, the method comprising the step 1010a of selecting, by the processing unit 910, a CFI pattern, wherein the CFI pattern comprises a set of CFI values, and at least one CFI value indicates duration of at least one downlink control channel, and the step 1020a of encoding, by the encoding unit 940, the downlink control information carried on each of the downlink control channels based on the CFI pattern.

According to another embodiment illustrated in FIG. 10B a control information transmission method carried out by the network node 900′ or 900 may comprise the step 1010b of selecting, by the processing unit 910, a CFI pattern corresponding to multiple downlink control channels, and the step 1020b of transmitting, by the transmitting unit 920, information indicating the selected CFI pattern to a UE, for example UE 400′ or 400. Afterwards, in step 1030b, the encoding unit 940 may encode downlink control information based on the selected CFI pattern and the transmitting unit 940 may transmit, in step 1040b, the encoded downlink control information on the downlink control channels to the UE.

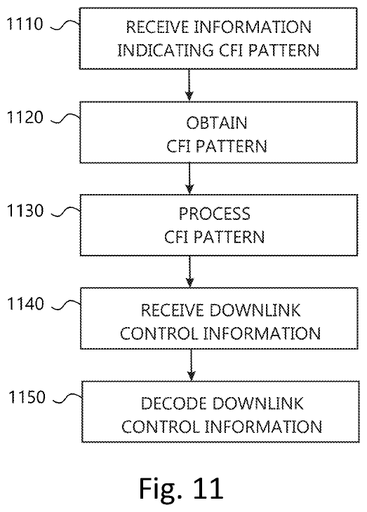

FIG. 11 illustrates an exemplary channel obtaining method performed by a UE, e.g. UE 400′ or 400, in response to actions performed by the network node 900′ or 900. In step 1110, the UE may receive information indicating CFI pattern from the network node 900′ or 900. Then, the processing unit 420 of the UE may obtain a CFI pattern from the received information in step 1120. In step 1130, the processing unit 420 may process the CFI pattern to obtain the CFI information and to retrieve the TTIs/sTTIs carrying the downlink control channels as explained in more detail above. In step 1140, the UE may receive downlink control information carried on each of the downlink control channels and may decode, in step 1150, the downlink control information based the obtained CFI pattern. Note that a detailed description of the components of the UE is omitted at this point for conciseness reasons and it is referred to the description of the embodiments of the UE 400′ or 400 as given above.

In summary, with the embodiments as given above, mechanisms for improved system efficiency are provided and schedule restrictions are avoided while correct transmission and processing of the control channel information conveyed in the control channels and simplified CFI value transmission are ensured.

Although detailed embodiments have been described, these only serve to provide a better understanding of the invention defined by the independent claims, and are not to be seen as limiting. In addition, although the embodiments have been described independently of each other, combinations of the above described embodiments may be used.

1. A User Equipment (UE) configured to obtain control information, the UE comprising:
a processing unit configured to obtain a Control Format Indicator (CFI) pattern, wherein the CFI pattern comprises a set of CFI values, and at least one CFI value indicates duration of at least one downlink control channel; and
a decoding unit configured to decode downlink control information carried on the at least one downlink control channel based on the CFI pattern.

2. The UE according to claim 1, wherein the set of CFI values corresponds to a set of Transmission Time Intervals (TTIs) or a set of short Transmission Time Intervals (sTTIs) within a frame.

3. The UE according to claim 2, wherein the set of TTIs comprises a downlink TTI and a special TTI; or
wherein the set of sTTIs comprises a downlink sTTI, and a special sTTI.

4. The UE according to claim 2, wherein the set of TTIs further comprises an uplink TTI; or
wherein the set of sTTIs further comprises an uplink sTTI.

5. The UE according to claim 2, wherein each CFI value corresponds to a TTI or a sTTI.

6. The UE according to claim 5, one or more TTIs or sTTIs corresponding to the at least one CFI value are configured for the at least one downlink control channel.

7. The UE according to claim 5, wherein the processing unit is configured to obtain the CFI value from the CFI pattern, the CFI value corresponding to a first set of TTIs/sTTIs; and
wherein the processing unit is configured to obtain a second CFI value by decrementing or incrementing the CFI value from the CFI pattern, the second CFI value corresponding to a second set of TTIs/sTTIs.

8. The UE according to claim 1, wherein the downlink control channel is a physical downlink control channel (PDCCH) or a short physical downlink control channel (sPDCCH).

9. The UE according to claim 1, wherein the CFI pattern is configured semi-statically.

10. The UE according to any of claim 1, wherein the CFI pattern is configured semi-statically, the UE further comprising:
a receiving unit configured to receive a Radio Resource Control (RRC) signal from a network node, wherein information indicating the CFI pattern is carried in the RRC signal, and
wherein the processing unit is configured to obtain the CFI pattern from the RRC signal.

11. A control information obtaining method, by a User Equipment, UE, comprising the steps of:
obtaining a Control Format Indicator (CFI) pattern, wherein the CFI pattern comprises a set of CFI values, and at least one CFI value indicates duration of at least one downlink control channel; and
decoding downlink control information carried on each of the downlink control channels based on the CFI pattern.

12. The control information obtaining method according to claim 11, wherein the set of CFI values corresponds to a set of Transmission Time Intervals (TTIs), or a set of short Transmission Time Intervals (sTTIs) within a frame.

13. The control information obtaining method according to claim 12, wherein the set of TTIs comprises a downlink TTI and a special TTI; or
wherein the set of sTTIs comprises a downlink sTTI, and a special sTTI.

14. The control information obtaining method according to claim 13, wherein the set of TTIs further comprises an uplink TTI; or
wherein the set of sTTIs further comprises an uplink sTTI.

15. The control information obtaining method according to claim 14, wherein each CFI value corresponds to a TTI or a sTTI.

16. The control information obtaining method according to claim 15, one or more TTIs or sTTIs corresponding to the at least one CFI value are configured for the at least one downlink control channel.

17. The control information obtaining method according to claim 15, wherein the CFI value is obtained from the CFI pattern, the CFI value corresponding to a first set of TTIs/sTTIs; and
wherein a second CFI value is obtained by decrementing or incrementing the CFI value from the CFI pattern, the second CFI value corresponding to a second set of TTIs/sTTIs.

18. The control information obtaining method according to claim 11, wherein the downlink control channel is a physical downlink control channel (PDCCH) or a short physical downlink control channel (sPDCCH).

19. The control information obtaining method according to claim 11, wherein the CFI pattern is configured semi-statically.

20. The control information obtaining method according to claim 11, wherein the CFI pattern is configured semi-statically, comprising the steps of:
receiving a Radio Resource Control (RRC) signal from a network node, wherein information indicating the CFI pattern is carried in the RRC signal, wherein the CFI pattern is obtained from the RRC signal.
